(19) United States
(12) Patent Application Publication
(10) Pub. No.: US 2025/0013399 A1
(43) Pub. Date: Jan. 9, 2025

(54) NON-TRANSITORY COMPUTER-READABLE RECORDING MEDIUM STORING COMPUTER-READABLE INSTRUCTIONS FOR TERMINAL DEVICE, NON-TRANSITORY COMPUTER-READABLE RECORDING MEDIUM STORING COMPUTER-READABLE INSTRUCTIONS FOR SERVER, AND CONTROL METHOD OF SYSTEM

(71) Applicant: BROTHER KOGYO KABUSHIKI KAISHA, Nagoya (JP)

(72) Inventor: Megumi HATA, Nagakute (JP)

(21) Appl. No.: 18/760,462

(22) Filed: Jul. 1, 2024

(30) Foreign Application Priority Data
Jul. 4, 2023 (JP) 2023-110039

(51) Int. Cl. G06F 3/12; G06Q 30/0601; H04N 1/34

(52) U.S. Cl. CPC G06F 3/121; G06F 3/1204; G06F 3/1292; G06Q 30/0613; H04N 1/344

(57) ABSTRACT

A computer-readable instructions, when executed by a processor of the terminal device, may cause the terminal device to: display, on a display unit of the terminal device, service guidance information guiding a user of the terminal device to a service suitable for a print device identified by identification information stored in a memory of the terminal device, and wherein in a case where a first condition that a specific period elapses since Nth service guidance information is displayed on the display unit is fulfilled, the computer-readable instructions cause the terminal device to display (N+1)th service guidance information on the display unit, wherein N is an integer greater than or equal to 1.

### REFERENCE TO RELATED APPLICATIONS

This application claims priority from Japanese Patent Application No. 2023-110039 filed on Jul. 4, 2023. The entire content of the priority application is incorporated herein by reference.

### BACKGROUND ART

An information processing device, which presents information introducing a service to order a consumable when a remaining amount of the consumable in a printer becomes equal to or below a predetermined threshold value, is known.

### SUMMARY

In the above technique, information introducing a consumable ordering service is displayed each time the remaining amount of the consumable decreases. For example, a frequency at which a printer is used is not constant. When the printer is not used frequently, the information introducing the consumable ordering service is not displayed, and a user may forget to sign up for the ordering service. On the other hand, when the printer is used frequently, the information introducing the ordering service is frequently displayed, which may become irritating for the user. The present disclosure provides a technique for displaying service guidance information at an appropriate frequency.

A non-transitory computer-readable recording medium storing computer-readable instructions for a terminal device is disclosed herein. The computer-readable instructions, when executed by a processor of the terminal device, may cause the terminal device to: display, on a display unit of the terminal device, service guidance information guiding a user of the terminal device to a service suitable for a print device identified by identification information stored in a memory of the terminal device, and wherein in a case where a first condition that a specific period elapses since Nth service guidance information is displayed on the display unit is fulfilled, the computer-readable instructions cause the terminal device to display (N+1)th service guidance information on the display unit, wherein N is an integer greater than or equal to 1.

The first condition for displaying the (N+1)th service guidance information is that the specific period elapses since the Nth service guidance information is displayed, and the first condition tends not to be affected by a frequency at which the print device is used. According to the above configuration, the service guidance information can be displayed at an appropriate frequency.

The above terminal device itself and a control method for the above terminal device are also novel and useful.

A non-transitory computer-readable recording medium storing computer-readable instructions for a server configured to communicate with a terminal device is disclosed herein. The computer-readable instructions, when executed by a processor of the server, may cause the server to: send, to the terminal device, data for displaying service guidance information guiding a user of the terminal device to a service suitable for a print device configured to communicate with the terminal device, wherein in a case where a first condition that a specific period elapses since the Nth service guidance information is displayed on the terminal device is fulfilled, the computer-readable instructions cause the server to send data for displaying (N+1)th service guidance information, wherein N is an integer greater than or equal to 1.

The above server itself and a control method for the above server are also novel and useful.

A control method of a system configured to cause a terminal device to display information is disclosed herein. The control method may comprise: causing the terminal device to display service guidance information guiding a user of the terminal device to a service suitable for a print device configured to communicate with the terminal device, wherein in a case where a first condition that a specific period elapses since Nth service guidance information is displayed on the display unit is fulfilled, the terminal device displays (N+1)th service guidance information, wherein N is an integer greater than or equal to 1. The system itself is also novel and useful.

### BRIEF DESCRIPTION OF DRAWINGS

FIG. 1 illustrates a block diagram of a communication system.

FIG. 2 schematically illustrates databases.

FIG. 3 illustrates a flowchart of processes by an app.

FIG. 4 illustrates a flowchart of a display determination process.

FIG. 5 illustrates a flowchart of a display process.

FIG. 6 illustrates a flowchart of processes by an app.

FIG. 7 illustrates a block diagram of a communication system.

FIG. 8 illustrates a sequence diagram of processes realized by the communication system.

### FIRST EMBODIMENT

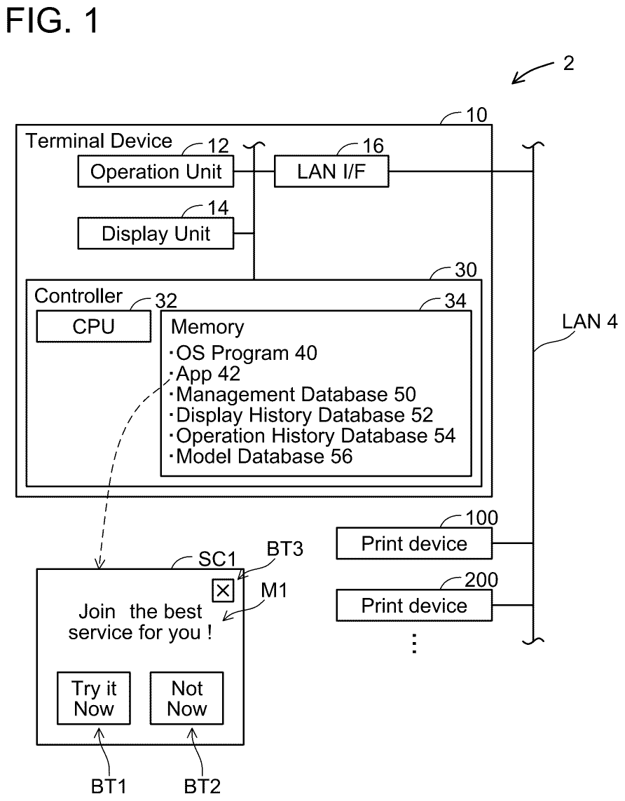

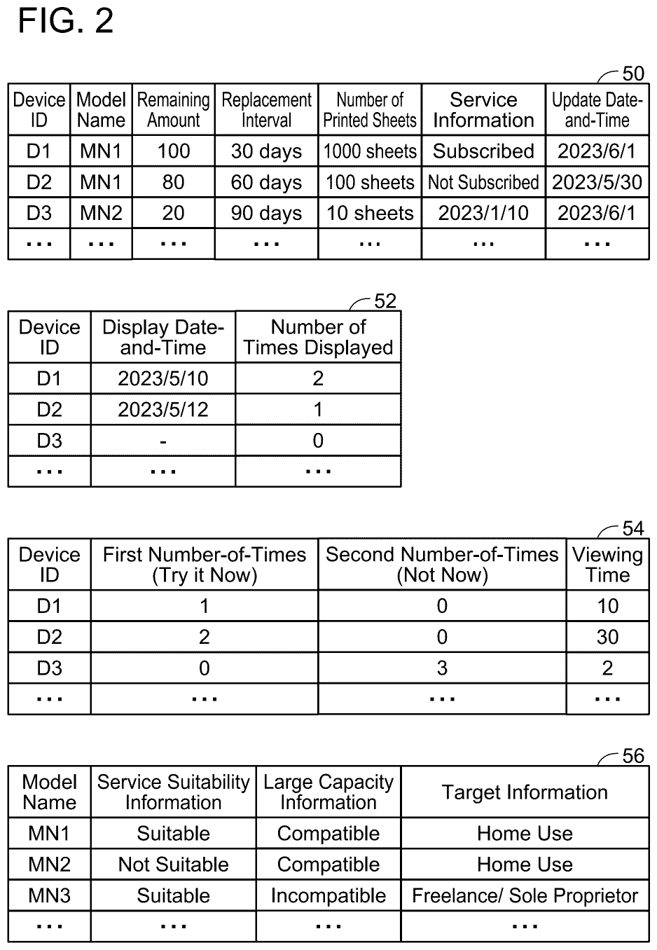

### Configuration of Communication System 2; FIGS. 1 and 2

A communication system 2 includes a terminal device 10 and a plurality of print devices 100, 200. The terminal device 10 can communicate with each of the print devices 100, 200 via a Local Area Network (LAN) 4. The LAN 4 is a wireless or a wired LAN. In a modification, the number of the plurality of print devices may be three or more. In another modification, the communication system 2 may have only one print device 100.

The terminal device 10 is, for example, a desktop PC, a laptop PC, a smartphone, or a tablet terminal. Each of the print devices 100 and 200 is a peripheral device (e.g., a peripheral device of the terminal device 10) configured to execute a printing function. In a modification, the print device (e.g., the print device 100) may be a multifunctional device that has multiple functions such as scanning and fax functions in addition to the printing function.

The printing function is realized by a print engine that operates by an electrophotographic scheme, inkjet scheme, or thermal scheme. The print engine of the electrophotographic scheme includes a photoreceptor, an exposure device that emits light and exposes the photoreceptor thereto, and the like. The print engine of the inkjet scheme includes a print head that ejects ink droplets. The print engine of the thermal scheme includes a print head that emits heat using a heater.

### Configuration of Terminal Device 10; FIG. 1, FIG. 2

The terminal device 10 includes an operation unit 12, a display unit 14, a LAN interface 16, and a controller 30. In the following, “interface” is described as “I/F”.

The operation unit 12 includes a plurality of keys. The user can input various instructions to the terminal device 10 by operating the operation unit 12. The display unit 14 is a display that displays various information. The display unit 14 may function as a touch screen, i.e., an operation unit that accepts operations by the user. The display unit 14 is, for example, an Liquid Crystal Display (LCD) or an Organic Light Emitting Diode (OLED) display. The LAN I/F 16 is an I/F for executing communication via the LAN 4 and is connected to the LAN 4.

The controller 30 includes a CPU 32 and a memory 34. The memory 34 includes a main storage device and an auxiliary storage device. The main storage device includes, for example, a RAM, cache memory, and the like. The auxiliary storage device may be, for example, a flash memory, Solid State Drive (SSD) or ROM, or a combination thereof.

The memory 34 stores an OS program 40 and an application program 42 (hereinafter referred to as “app 42”). The OS program 40 is a program for controlling the basic operation of the terminal device 10. The app 42 is a program for controlling a print device (e.g., the print device 100) via the LAN 4. For example, if a plurality of print devices is connected to the LAN 4, the app 42 can control the plurality of print devices. Each of the programs 40 and 42 is stored in the auxiliary storage of the memory 34. The CPU 32 executes various processes according to each of the programs 40 and 42 loaded from the auxiliary storage device to the main storage device. The app 42 accesses hardware, such as the display unit 14, via the OS program 40. In the following description, the process executed by the OS program 40 when the app 42 accesses the hardware is omitted.

In addition to controlling the print devices, the app 42 also has a function of displaying a service guidance screen SC1, which guides the user to a service related to the print device. Here, the service is, for example, a shipping service that automatically ships a new color material cartridge when a remaining amount of the color material cartridge installed in the print device falls to or below a predetermined value. The color material cartridge is, for example, an ink cartridge or a toner cartridge.

The service guidance screen SC1 is a pop-up screen. In a modification, the service guidance screen SC1 may be a notification screen such as a banner or a toast notification. The service guidance screen SC1 includes a message M1, a first button BT1, a second button BT2, and an end button BT3. The message M1 is a message that prompts the user to subscribe to the service. The first button BT1 is a button to proceed to a subscription process to subscribe to the service. For example, the first button BT1 is assigned a URL that indicates a web page for subscribing to the service. When the first button BT1 is selected, the app 42 starts a browser program. The browser program then displays the web page indicated by the URL assigned to the first button BT1. In this case, the service information screen SC1 is shielded from view by the web page. In a modification, the app 42 may display a screen for subscribing to the service instead of the service guidance screen SC1.

The second button BT2 is for not proceeding to the subscription process described above. When the second button BT2 is selected, the display of the service guidance screen SC1 ends. The end button BT3 is a different button to end the display of the service guidance screen SC1.

For example, when the app 42 can control a plurality of print devices, for each of the plurality of print devices, the app 42 displays the service guidance screen SC1 related to the print device. For example, a situation in which a model of a first print device and a model of a second print device are different is assumed. In this case, a URL assigned to the first button BT1 in the service guidance screen SC1 related to the first print device and a URL assigned to the first button BT1 in the service guidance screen SC1 for the second print device may be different. This is because, for example, a color material cartridge compatible with the first print device is different from a color material cartridge compatible with the second print device.

The memory 34 further stores a management database 50, a display history database 52, an operation history database 54, and a model database 56.

The management database 50 is a database that manages a plurality of print devices that the app 42 can control. The management database 50 stores, for each of the plurality of print devices, a device ID, a model name, a remaining amount, a replacement interval, the number of printed sheets, service information, and update date and time. The device ID is an ID that identifies the corresponding print device. The model name indicates a model of the corresponding print device. The remaining amount is a remaining amount of a color cartridge currently installed in the corresponding print device. The replacement interval is an average value of intervals at which the color cartridge is replaced. The number of printed sheets is the number of sheets printed per unit month in the corresponding print device. The service information indicates a subscription status of the service in the corresponding print device. For example, if the corresponding print device currently subscribes to the service, the service information indicates “subscribed”. When the corresponding print device has never subscribed to the service, the service information indicates “not subscribed”. When the corresponding print device subscribed to the service in the past but does not subscribe to the service at the moment, the service information indicates the date and time when use of the service ended (i.e., the date and time when the corresponding print device unsubscribed from the service). Here, the status information including the remaining amount, the replacement interval, the number of printed sheets, and the service information is received from each print device and stored in the management database 50. The update date and time indicates the date and time when the status information in the management database 50 was updated.

The display history database 52 is a database that stores the history of display of the service guidance screen SC1 for each of the plurality of print devices that the app 42 can control. The display history database 52 stores, for each of the plurality of print devices, a device ID, display date and time, and a number of times displayed. The display date and time is the date and time when the service guidance screen SC1 was last displayed on the corresponding print device. The number of times displayed is the cumulative number of times the service guidance screen SC1 was displayed on the corresponding print device.

The operation history database 54 is a database that stores the history of the operation on the service guidance screen SC1 for each of the plurality of print devices which the app 42 can control. The operation history database 54 stores, for each of the plurality of print devices, a device ID, the first number of times, the second number of times, and a viewing time in association with the print device. The first number of times is the number of times the first button BT1 on the service guidance screen SC1 was selected. The second number of times is the number of times the second button BT2 on the service guidance screen SC1 was selected. The viewing time is an average value of time during which the service guidance screen SC1 was viewed by the user. The viewing time may for example be the time from the start to the end of the display of the service guidance screen SC1. Further, the viewing time may for example be the time from the start of the display of the service guidance screen SC1 to the time when the service guidance screen SC1 is hidden by other screen(s). In a modification, the viewing time may be a maximum value, an intermediate value, etc. of the time during which the service guidance screen SC1 is viewed by the user.

The model database 56 is a database that stores information about a plurality of types of models. The model database 56 stores, for each of the plurality of types of models, a model name, service suitability information, large capacity information, and target information in association with the model. The service suitability information indicates a value that is either “suitable” or “not suitable”. The service suitability information “suitable” indicates that the corresponding model can subscribe to the service. The service suitability information “not suitable” indicates that the corresponding model cannot subscribe to the service. The large capacity information indicates a value that is either “compatible” or “not compatible”. The large capacity information “compatible” indicates that there is a large-capacity color cartridge that can be installed to the corresponding model. The large capacity information “not compatible” indicates that there is no large-capacity color cartridge that can be installed to the corresponding model. The target information indicates a target that is expected to purchase the corresponding model. The target information indicates, for example, “home use”, “freelance/sole proprietor”, or “small business”.

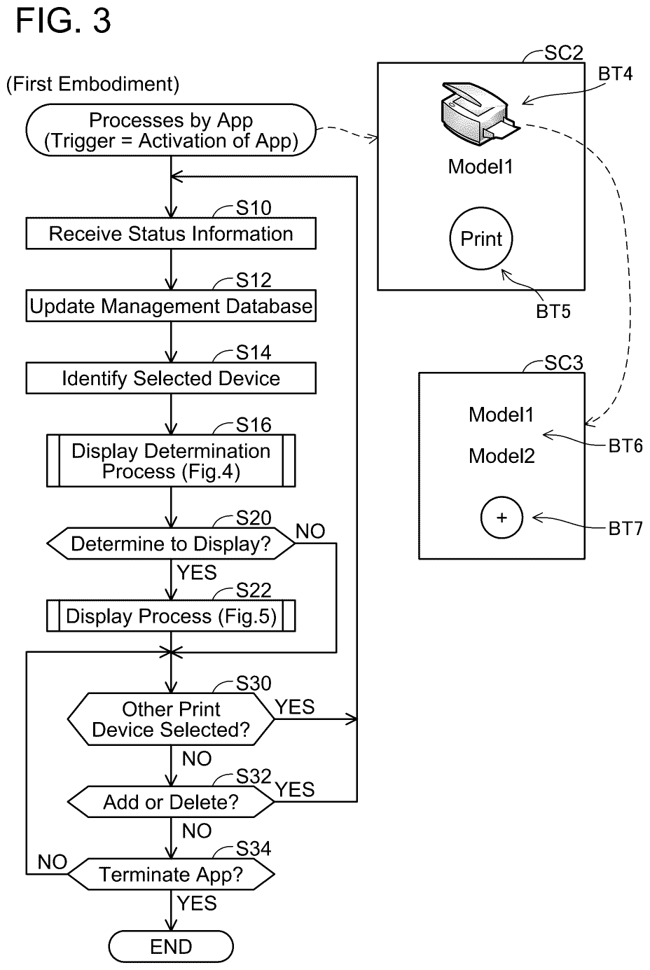

### Processes by App; FIG. 3

Referring to FIG. 3, processes that the CPU 32 executes according to the app 42 will be described. Execution of the processes in FIG. 3 is triggered by the app 42 being activated. When the app 42 is activated, the CPU 32 displays a main screen SC2 on the display unit 14. The main screen SC2 includes a device button BT4 and a print button BT5. The device button BT4 is a button for setting a print device to be controlled. When the device button BT4 is selected, the CPU 32 displays a setting screen SC3 on the display unit 14. The setting screen SC3 includes a select button BT6 and an add button BT7.

The select button BT6 includes a list of print devices managed by the management database 50. For example, when the model name “Modell” is selected from the list of the select button BT6, the CPU 32 determines the print device 100 corresponding to the model name “Modell” as a device to be controlled. In this case, an icon indicating the print device 100 to be controlled is displayed on the device button BT4.

The add button BT7 is a button for adding a print device to the management database 50. For example, when the add button BT7 is selected, the CPU 32 searches the LAN4. When a print device not registered with the management database 50 is found from the LAN 4, the CPU 32 asks the user whether to add the found print device. When the CPU 32 is instructed to add the found print device by the user, the CPU 32 registers the found print device with the management database 50. Specifically, the CPU 32 stores a device ID identifying the found print device in the management database 50.

The print button BT5 in the main screen SC2 is a button to cause the print device to be controlled indicated by the icon in the device button BT4 to execute printing. Specifically, when the print button BT5 is selected, the CPU 32 sends print data to the print device to be controlled via the LAN I/F 16. As a result, the print device to be controlled executes printing according to the print data.

When the app 42 is activated, the CPU 32 executes processes from S10 in addition to displaying the main screen SC2. In S10, the CPU 32 receives status information from each of the plurality of print devices registered in the management database 50 via the LANI/F 16.

In S12, the CPU 32 updates the management database 50 by storing each status information received in S10 in the management database 50.

In S14, the CPU 32 identifies the print device selected at the selection button BT6 in the setting screen SC3 (hereinafter described as “selected device”). The selected device is a print device displayed as an icon on the device button BT4 and is a print device to be controlled.

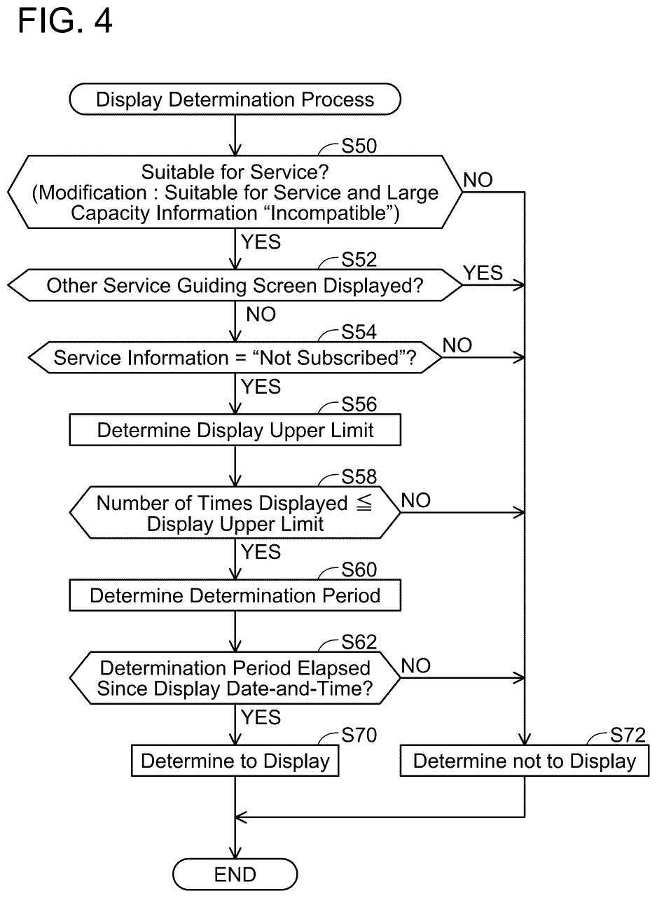

In S16, the CPU 32 executes a display determination process (see FIG. 4) to determine whether to display the service guidance screen SC1 related to the selected device identified in S14. In S20, the CPU 32 determines if it has been determined whether to display the service guidance screen SC1 in the display determination process in S16. When the CPU 32 determines that it has been determined not to display the service guidance screen SC1 (NO in S20), it skips S22 described below and proceeds to S30. On the other hand, when the CPU 32 determines that it has been determined to display the service guidance screen SC1 (YES in S20), it proceeds to S22.

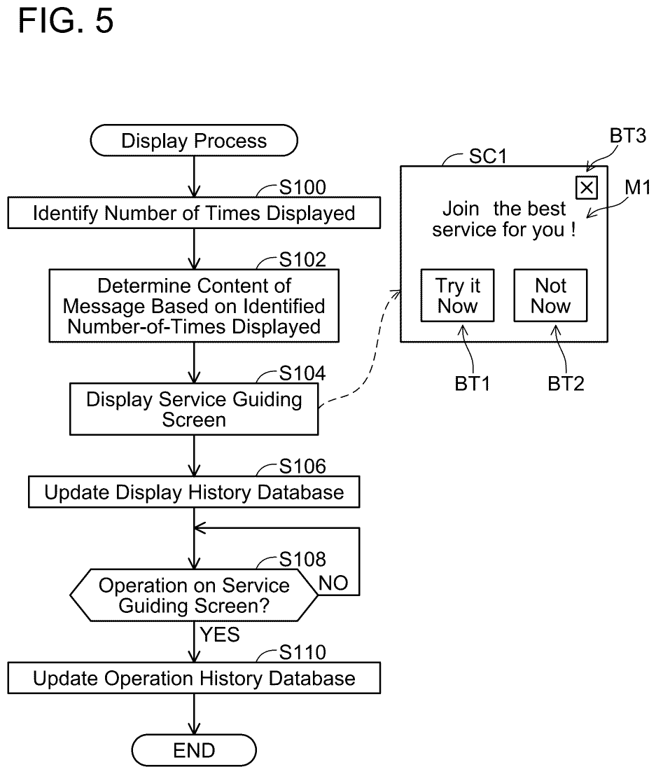

In S22, the CPU 32 executes a display process (see FIG. 5) to display the service guidance screen SC1. When the display process of S22 ends, the CPU 32 proceeds to S30. In S30, the CPU 32 monitors a print device different from the selected print device identified in S14 being selected as a print device to be controlled in the setting screen SC3. When the different print device is selected as a print device to be controlled (YES in S30), the CPU 32 returns to S10.

When no other print device is selected as the print device to be controlled (NO in S30), the CPU 32 proceeds to S32. In S32, the CPU 32 monitors either a print device being added to the management database 50 or a device ID being deleted from the management database 50. The CPU 32 returns to S10 when a print device is added to the managed database 50 (YES in S32). The CPU 32 also returns to S10 when a device ID is deleted from the management database 50 (YES in S32). Here, the deletion of the device ID is executed, for example, by a deletion instruction being inputted on the setting screen SC3. The deletion instruction can be inputted, for example, by long-pressing the select button BT6. In a modification, the deletion instruction may be inputted on a screen different from the setting screen SC3.

When no print device is added to the management database 50 and no device ID is deleted from the management database 50 (NO in S32), the CPU 32 proceeds to S34. In S34, the CPU 32 monitors that an instruction to terminate the app 42 being inputted to the operation unit 12. When no instruction to terminate the app 42 is inputted to the operation unit 12 (NO in S34), the CPU 32 returns to S30. On the other hand, the CPU 32 ends the process of FIG. 3 when an instruction to terminate the app 42 is inputted to the operation unit 12 (YES in S34).

### Display Determination Process; FIG. 4

Referring to FIG. 4, the display determination process of S16 in FIG. 3 will be described. In S50, the CPU 32 determines whether the selected device identified in S14 in FIG. 14 is suitable for the service. Specifically, the CPU 32 identifies the model name stored in association with the device ID of the selected device from the management database 50. The CPU 32 identifies the service suitability information stored in association with the identified model name from the model database 56. The CPU 32 determines that the selected device is capable of using the service when the identified service suitability information indicates “suitable”.

When the CPU 32 determines that the selected device is suitable for the service (YES in S50), it proceeds to S52. On the other hand, when the CPU 32 determines that the selected device is not suitable for the service (NO in S50), the CPU 32 skips processes from S52 and proceeds to S72. In S72, the CPU 32 determines not to display the service guidance screen SC1. When S72 ends, the CPU 32 ends the process in FIG. 4.

In S52, the CPU 32 determines whether a service guidance screen SC1 related to a print device different from the selected device is displayed on the display unit 14 during the period from activation to end of the app 42. When the CPU 32 determines that the service guidance screen SC1 related to the different print device is displayed on the display unit 14 (YES in S52), it skips processes from S54 and proceeds to S72. On the other hand, when the CPU 32 determines that the service guidance screen SC1 related to the different print devices is not displayed on the display 14 (NO in S52), it proceeds to S54.

In S54, the CPU 32 identifies service information stored in association with the device ID of the selected device from the management database 50. Then, the CPU 32 determines whether the identified service information indicates “Not Subscribed”. When the CPU 32 determines that the identified service information does not indicate “Not Subscribed” (NO in S54), it skips processes from S56 and proceeds to S72. On the other hand, when the CPU 32 determines that the identified service information indicates “Not Subscribed” (YES in S54), it proceeds to S56.

In S56, the CPU 32 determines a display upper limit, which is an upper limit of number of times the service guidance screen SC1 related to selected device is displayed. In the present embodiment, the display upper limit is determined based on information indicating the current running status of the selected device. The information indicating the running status is, for example, the remaining amount, replacement interval, and number of printed sheets stored in the management database 50. For example, the CPU 32 determines a level indicating a running frequency of the selected device to be “high”, “medium”, or “low” based on the information indicating the running status. For example, the level “medium” indicates that the replacement interval is within a predetermined value range, the level “high” indicates that the replacement interval is at or below the lower limit of the predetermined value range, and the level “low” indicates that the replacement interval is at or above the upper limit of the predetermined value range. When the CPU 32 determines the level “medium”, the CPU 32 determines a default value (e.g., 3) as the display upper limit. When the CPU 32 determines the level “high”, the CPU 32 determines a value greater than the default value (e.g., 5) as the display upper limit. When the CPU 32 determines the level “low”, the CPU 32 determines a value smaller than the default value (e.g., 1) as the display upper limit. In a modification, each level may be determined by the number of sheets printed or by an amount of change per unit time in the remaining amount. In another modification, each level may be determined by a combination of at least two of: the remaining amount; the replacement interval; and the number of printed sheets. In yet another modification, the levels indicating the running frequency of the selected device may not be limited to three levels, but may be two or four levels.

In S58, the CPU 32 identifies the number of times displayed stored in association with the device ID of the selected device from the display history database 52. Then, the CPU 32 determines whether the identified number of times displayed is less than or equal to the display upper limit determined in S56. When the CPU 32 determines that the identified number of times displayed is greater than the display upper limit (NO in S58), it proceeds to S72. On the other hand, when the CPU 32 determines that the identified number of times displayed is less than or equal to the display upper limit (YES in S58), it proceeds to S60. The determination in S58 using the display upper limit can suppress excessively repetitive display of the service guidance screen SC1. The display upper limit is determined based on the running frequency of the selected device. For example, it is possible to prompt a user, who uses the selected device with a high frequency, to subscribe to the service. Further, it is possible to suppress excessively repetitive display of the service guidance screen SC1 for users who use the selected device infrequently.

In S60, the CPU 32 determines a determination period for determining whether to display the service guidance screen SC1 related to the selected device. In the present embodiment, the determination period is determined based on the information indicating the current running status of the selected device, similar to the display upper limit in S56. The CPU 32 determines the level indicating the running frequency of the selected device to be “high”, “medium”, or “low”, similar to S56. When the CPU 32 determines the level “medium”, the CPU 32 determines a default period (e.g., seven days) as the determination period. When the CPU 32 determines the level “high”, the CPU 32 determines a period shorter than the default value (e.g., three days) as the determination period. When the CPU 32 determines the level “low”, the CPU 32 determines a period longer than the default value (e.g., fourteen days) as the determination period. For example, it is possible to repeatedly guide the user who frequently uses the selected device to the service at a short interval and to suppress the user from forgetting to subscribe to the service. Further, it is possible to suppress repetitive display of the service guidance screen SC1 at a short interval for the user who uses the selected device infrequently.

In S62, the CPU 32 identifies, from the display history database 52, the display date and time stored in association with the device ID of the selected device. Then, the CPU 32 determines whether the determination period determined in S60 has elapsed from the identified display date and time. When the CPU 32 determines that the determination period has not elapsed from the identified display date and time (NO in S62), the CPU 32 proceeds to S72. On the other hand, when the CPU 32 determines that the determination period has elapsed from the identified display date and time (YES in S62), the CPU 32 proceeds to S70.

In S70, the CPU 32 determines to display the service guidance screen SC1. When S70 ends, the CPU 32 ends the process of FIG. 4.

### Display Process; FIG. 5

Referring to FIG. 5, the display process of S22 in FIG. 3 will be described. In S100, the CPU 32 identifies the number of times displayed stored in association with the device ID of the selected device from the display history database 52.

In S102, the CPU 32 determines the content of the message M1 in the service guidance screen SC1 based on the number of times displayed identified in S100. For example, the CPU 32 increases the amount of information to be displayed as the message M1 as the identified number of times displayed increases. For example, when the number of times displayed is “1”, the message M1 includes one sentence, and when the number of times displayed is “2”, the message M1 includes two sentences. The two sentences are, for example, a sentence introducing the existence of the service and a sentence introducing the content of the service (e.g., shipment of a color material cartridge). In a modification, the CPU 32 may reduce the amount of information displayed as the message M1 as the identified number of times displayed increases. According to this configuration, the content of the service guidance screen SC1 can be changed according to the number of times the user views the service guidance screen SC1. By changing the content of the service guidance screen SC1, it is expected to prompt the user to change his/her action.

The information indicating the content of the message M1 is stored, for example, in a server on the Internet (not illustrated) accessible by using the app 42. The CPU 32 sends the number of times displayed identified in S100 to this server and receives the information indicating the content of the message M1 from this server. In a modification, the information indicating the content of the message M1 may be stored in the terminal device 10.

In subsequent S104, the CPU 32 displays the service guidance screen SC1 on the display unit 14. In S106, the CPU 32 updates the display history database 52. Specifically, the CPU 32 changes the display date and time stored in association with the device ID of the selected device to the current date and time, and increments the number of times displayed stored in association with the device ID of the selected device.

In S108, the CPU 32 monitors for an operation performed on the service guidance screen SC1. The operation on the service guidance screen SC1 is, for example, any one of selection of the first button BT1, selection of the second button BT2, or selection of the end button BT3. The CPU 32 repeats the determination of S108 until an operation on the service guidance screen SC1 is executed. When the operation is executed on the service guidance screen SC1 (YES in S108), the CPU 32 proceeds to S110.

In S110, the CPU 32 updates the operation history database 54. For example, when the first button BT1 is selected in S108, the CPU 32 increments the first number of times stored in association with the device ID of the selected device in the operation history database 54. When the second button BT2 is selected in S108, the CPU 32 increments the second number of times stored in association with the device ID of the selected device in the operation history database 54. The CPU 32 also identifies a time from the start of the display of the service guidance screen SC1 in S104 to the operation in S108. The identified time corresponds to the viewing time of the service guidance screen SC1 displayed in S104. The CPU 32 calculates a new average value from the identified time and the viewing times stored in association with the device ID of the selected device in the operation history database 54. Then, the CPU 32 stores the new average value in the operation history database 54 as the new viewing time. When the process of S110 ends, the CPU 32 ends the process of FIG. 5.

### Effects of Present Embodiment

According to the configuration of the present embodiment, the process of FIG. 3 is executed each time the app 42 is activated, and the service guidance screen SC1 is repeatedly displayed by the display process in S22 of FIG. 3. Here, the condition for displaying the service guidance screen SC1 is that the determination period elapses from the time at which the previous service guidance screen SC1 is displayed (S60 at FIG. 4). For example, a comparative example is assumed in which the service guidance screen SC1 is displayed when the remaining amount of the color material cartridge in the print device 100 is at or below a predetermined value. In this comparative example, the service guidance screen SC1 is not displayed during a period when the print device 100 is used infrequently, and the user may forget to subscribe to the service. On the other hand, when the print device 100 is used frequently, the service guidance screen SC1 is displayed frequently, which may be irritate the user. In contrast, the condition for displaying the service guidance screen SC1 in the present embodiment is a condition based on the determination period and tends not to be affected by the frequency of use of the print device 100. The service guidance screen SC1 can be displayed at an appropriate frequency.

According to the configuration of the present embodiment, the service guidance screen SC1 is displayed when the determination period elapses from the time at which the previous service guidance screen SC1 is displayed and when the service information indicates “not subscribed”. The condition based on the determination period allows the frequent display of the service guidance screen SC1 to be suppressed while only the user who has not yet subscribed to the service can be guided to the service.

Further, for example, a situation in which communication with the print device 100 fails in S10 of FIG. 3 can be assumed. In this case, the service information related to the print device 100 in the management database 50 is not updated. However, the service information received in the past from the print device 100 is stored in the management database 50. When communication with the print device 100 fails in S10, the CPU 32 determines whether to display the service guidance screen SC1 by using the service information received in the past (S54 in FIG. 4). According to this configuration, even when communication with the print device 100 fails, the service guidance screen SC1 can be displayed to guide the user to the service. In a modification, the above configuration that uses the service information received in the past can be omitted.

According to the configuration of the present embodiment, the display determination process is executed for the selected device (S14 and S16 in FIG. 3). In other words, the service guidance screen SC1 related to the selected device is displayed, and the service guidance screen SC1 related to another print devices different from the selected device is not displayed. For example, a comparative example is assumed in which the service guidance screen SC1 related to the print device 200 is displayed even though the user is using the print device 100 as the selected device. In this comparative example, the user may misunderstand that the service guidance screen SC1 related to the print device 200 is the service guidance screen SC1 related to the print device 100 that the user is currently using. In contrast, according to the configuration of the present embodiment, the user will not misunderstand because the service guidance screen SC1 related to another print device different from the selected device is not displayed.

A situation is assumed in which the service guidance screen SC1 related to the print device 100 is displayed when the print device 100 is selected as the selected device, and then the print device 200 is selected as the selected device (YES in S30 of FIG. 3). In this case, the display determination process is executed for the print device 200 (S16). For example, a comparative example in which the determination of S52 in FIG. 4 is not executed in the display determination process is assumed. In this comparative example, from the activation to the end of the app 42, the service guidance screen SC1 related to the print device 200 may be displayed after the service guidance screen SC1 related to the print device 100 is displayed. If the service guidance screens SC1 are displayed one after another, this may irritate the user. In contrast, according to the configuration of the present embodiment, the determination of S52 can suppress the service guidance screens SC1 from being displayed one after another. In a modification, the configuration of the comparative example above may be adopted.

### Modification of Process in S50

In S50, the CPU 32 may identify the service suitability information and the large capacity information stored in association with the model name of the selected device from the model database 56. Then, the CPU 32 may determine whether the identified service suitability information indicates “suitable” and the identified large capacity information indicates “incompatible”. When the CPU 32 determines that the identified service suitability information indicates “suitable” and the identified large capacity information indicates “incompatible” (YES in S50), it may proceed to S52, and otherwise (NO in S50), it may proceed to S72. This is because, for example, a shipping service may be designed to ship a regular color material cartridge and not a large capacity color material cartridge.

### Modification 1 of Processes of S56 and S60

The display upper limit in S56 and the determination period in S60 may be determined based on the information stored in the operation history database 54. It is possible to estimate from the information stored in the operation history database 54 how much the user is interested in the service. For example, the second number of times being greater than the first number of times and the viewing time being shorter than the predetermined value means that the user often selects the second button BT2 immediately. Since the user selects the second button BT2 immediately, it can be assumed that the user is not interested in the service. In such a case, the CPU 32 may determine a value smaller than the default value as the display upper limit and may further determine a period longer than the default value as the determination period.

Further, for example, the second number of times being greater than the first number of times and the viewing time being longer than the predetermined value means that the user often selects the second button BT2 on the service guidance screen SC1 after being indecisive between the first button BT1 and the second button BT2. In such a case, the CPU 32 may determine a default value as the display upper limit and further determine a period longer than the default value as the determination period.

Further, for example, the second number of times being smaller than the first number of times and the viewing time being longer than the predetermined value means that the user often selects the first button BT1 on the service guidance screen SC1 after giving thought. In such a case, the CPU 32 may determine a value greater than the default value as the display upper limit and further determine a default value as the determination period.

Further, for example, the second number of times being smaller than the first number of times and the viewing time being shorter than the predetermined value means that the user often immediately selects the first button BT1. Since the user immediately selects the first button BT1, it can be inferred that the user is interested in the service. In such a case, the CPU 32 may determine a value greater than the default value as the display upper limit, and may further determine a period shorter than the default value as the determination period. The specific determination method described above is only an example. For example, the display upper limit and the determination period may be determined based only on the viewing time. In this case, the operation history database 54 may store the viewing time and may not store the first number of times or the second number of times. For example, the display upper limit and the determination period may be determined based only on the first number of times. Further, for example, the display upper limit and the determination period may be determined based only on the second number of times.

### Modification 2 of Processes of S56 and S60

The display upper limit and the determination period may be determined based on the target information stored in the model database 56. For example, “freelance/sole proprietor” is more likely to use the shipping service than “home use” and “small business”. For example, when the target information corresponding to the selected device in the model database 56 indicates “freelance/sole proprietor”, the CPU 32 may determine a value greater than the default value as the display upper limit and may further determine a period shorter than the default value as the determination period. Further, for example, when the target information corresponding to the selected device in the model database 56 indicates “home use”, the CPU 32 may determine a value smaller than the default value as the display upper limit, and further determine a period longer than the default value as the determination period. Further, for example, when the target information corresponding to the selected device in the model database 56 indicates “small business”, the CPU 32 may determine a default value as the display upper limit and further determine a default value as the determination period.

The display upper limit and the determination period may be determined based on the large capacity information stored in the model database 56. For example, when the large capacity information indicates “compatible”, the CPU 32 may determine a value smaller than the default value as the display upper limit and may also determine a period longer than the default value as the determination period. This is because, as discussed above, the shipping service may be designed not to ship a large capacity color material cartridge. The specific determination method described above is only an example. For example, the display upper limit and the determination period may be determined based on the combination of the target information and the large capacity information.

### Modification 3 of Processes of S56 and S60

The method for determining the display upper limit may be different from the method for determining the determination period. For example, the display upper limit may be determined based on information indicating the current running status of the selected device, and the determination period may be determined based on information stored in the operation history database 54. The display upper limit and the determination period may be determined based on information obtained by a combination of at least two of the information in the display history database 52, the information in the operation history database 54, and the information in the model database 56.

### Corresponding Relationships

The terminal device 10, the display unit 14, and the CPU 32 are examples of

“terminal device”, “display unit”, and “processor”, respectively. The memory 34 and the app 42 are an example of “memory” and “computer-readable instructions for a terminal device”, respectively. The print device 100 is an example of a “print device”. The print devices 100 and 200 are examples of “a plurality of print devices”. The device ID and the device ID of the selected device are an example of “identification information” and “first identification information”, respectively. The service guidance screen SC1 is an example of “service guidance information”. The information in the operation history database 54 is an example of “a time during which the service guidance information is continuously displayed” and “information indicating a history of operations”. The remaining amount, the replacement interval, and the number of printed sheets are examples of “information indicating a running status”. The information in the model database 56 is an example of “a type of consumables being available” and “a model of the print device”. The status information (i.e., the remaining amount, replacement interval, number of sheets printed, and service information) received in S10 of FIG. 3 is an example of “current status information”. The condition determined in S62 in FIG. 4 is an example of “first condition”. The condition determined in S54 of FIG. 4 is an example of “third condition”.

The process of S22 in FIG. 3 is an example of “display, on the display unit, service guidance information”. The step realized by the process of S22 in FIG. 3 is an example of “causing the terminal device to display service guidance information”.

### SECOND EMBODIMENT

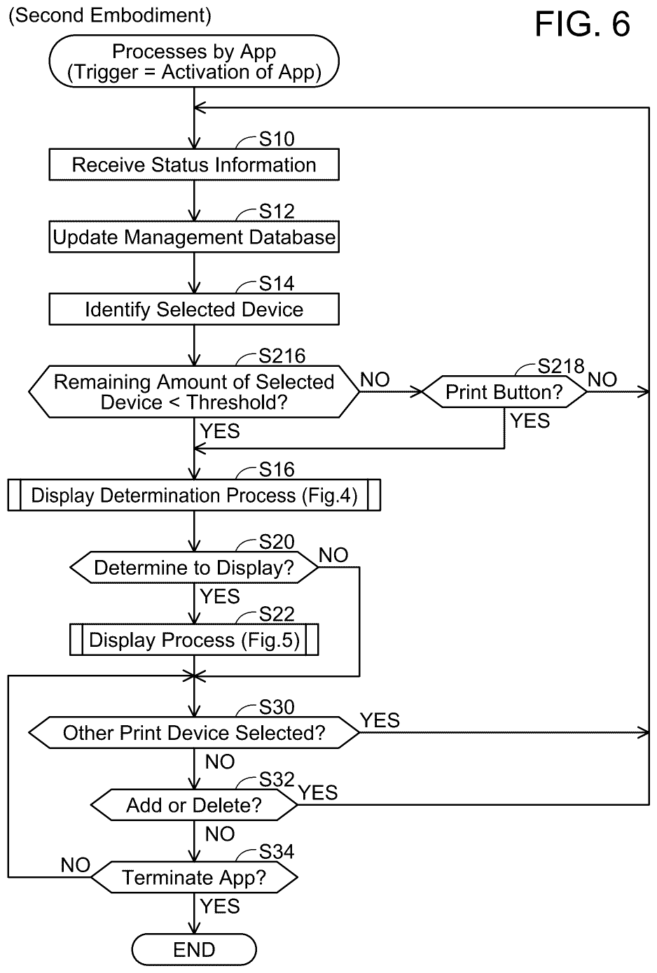

### Processes by App; FIG. 6.

The present embodiment is the same as the first embodiment, except that the content of the process by the app is different. Referring to FIG. 6, the content of the processes by the app is described. The trigger of the process of FIG. 6 is the same as the process in FIG. 3 of the first embodiment. In FIG. 6, the same processes as those in FIG. 3 are given the same reference signs.

When the CPU 32 identifies the selected device in S14, the CPU 32 executes the determination of S216. In S216, the CPU 32 identifies the remaining amount stored in association with the device ID of the selected device from the management database 50. Then, the CPU 32 determines whether the identified remaining amount is less than or equal to a threshold value. When the CPU 32 determines that the identified remaining amount is less than or equal to the threshold value (YES in S216), it proceeds to the processes from S16 to S34. On the other hand, the CPU 32 proceeds to S218 when the identified remaining amount is greater than the threshold value (NO in S216).

In S218, the CPU 32 monitors for a selection of the print button BT5 in the main screen SC2. When the print button BT5 in the main screen SC2 is selected (YES in S218), the CPU 32 proceeds to the processes of S16 to S34. When the print button BT5 within the main screen SC2 is not selected (NO in S218), the CPU 32 returns to S10.

For example, the remaining amount being less than or equal to the threshold value means that the time to replace the color material cartridge is approaching. In the situation where the time to replace the color material cartridge is approaching, the user may be more interested in the shipping service than in the situation where it is not the time to replace the color material. According to the configuration of the present embodiment, the service guidance screen SC1 is displayed when the user may get interested in the shipping service. The service guidance screen SC1 can be displayed at an appropriate timing when the user may get interested in the shipping service. Even in this case, excessively repetitive display of the service guidance screen SC1 is suppressed by the determination based on the determination period (see S62 in FIG. 4).

Further, for example, when communication with the print device 100 fails in S12 of FIG. 6, the CPU 32 executes the determination of S216 by using the remaining amount received in the past. According to this configuration, even when communication with the print device 100 fails, the service guidance screen SC1 can be displayed to guide the user to the service. In a modification, the above configuration that uses the remaining amount received in the past can be omitted.

Further, for example, the print button BT5 being selected means it is likely that the user looks at the display unit 14 while operating the operation unit 12. In such a situation, when the service guidance screen SC1 is displayed, there is a high possibility that the user views the service guidance screen SC1. The service guidance screen SC1 can be displayed at a timing when the user is likely to view the service guidance screen SC1. Even in this case, excessively repetitive display of the service guidance screen SC1 is suppressed by the determination based on the determination period (see S62 in FIG. 4).

### Corresponding Relationships

The condition determined in S216 and the condition determined in S218 in FIG. 6 are an example of “second condition” and “fifth condition”, respectively.

### THIRD EMBODIMENT

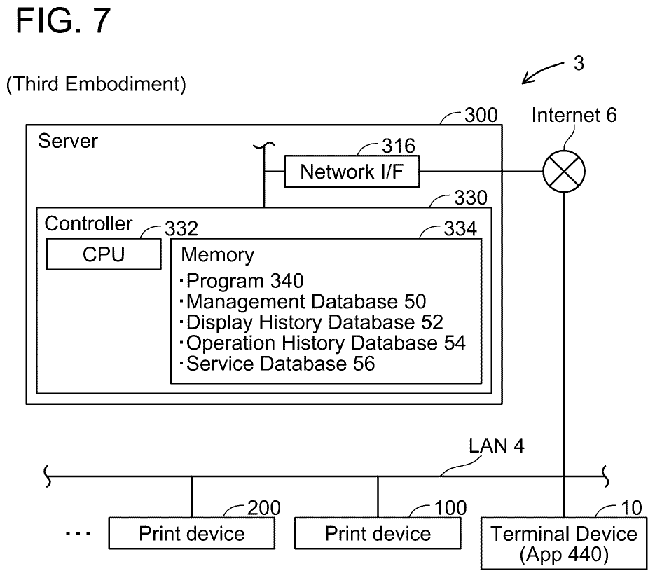

### Configuration of Communication System 3; FIG. 7

A communication system 3 of the present embodiment includes a terminal device 10, a plurality of print devices 100 and 200, and a server 300. The terminal device 10 of the present embodiment stores an app 440. As with the app 42 of the first embodiment, the app 440 includes a function of controlling the print devices and displaying a service guidance screen SC1. The app 440 further includes a function of executing communication with the server 300. The terminal device 10 and the plurality of print devices 100 and 200 can communicate with each other via a LAN 4. The LAN 4 is connected to the Internet 6. The server 300 is connected to the Internet 6. A device on the LAN 4 (e.g., the terminal device 10) can communicate with the server 300 via the Internet 6.

The server 300 manages the plurality of print devices 100 and 200. The server 300 operates in cooperation with the app 440. The server 300 is installed, for example, by a vendor of the app 440. The server 300 may be a single server or a unit obtained by combining multiple servers. The server 300 is a physical or virtual server.

As an example, a situation in which the server 300 is a physical server will be described. The server 300 includes a network I/F 316 and a controller 330. The network I/F 316 is an I/F for executing communication via the Internet 6 and is connected to the Internet 6.

The controller 330 includes a CPU 332 and a memory 334. The memory 334 includes a main storage device and an auxiliary storage device. The memory 334 stores a program 340. The memory 334 further stores a management database 50, a display history database 52, an operation history database 54, and a model database 56. The CPU 332 executes the display determination process of FIG. 4 according to the program 340 loaded from the auxiliary storage device to the main storage device.

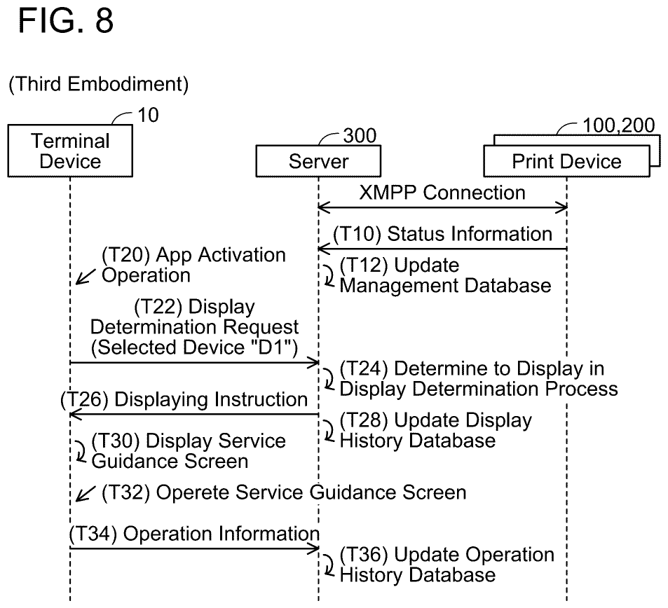

### Process Realized by Communication System 3: FIG. 8

In the present embodiment, the server 300 establishes an XMPP connection with each of the plurality of print devices 100 and 200 via the Internet 6 and the network I/F 316. XMPP stands for extensible Messaging and Presence Protocol. The XMPP connection is a so-called always-on connection, a connection that remains established until a print device is turned off. In a modification, instead of the XMPP connection, an HTTPS or MQTT connection may be established, for example. HTTPS stands for Hypertext Transfer Protocol Secure. MQTT stands for Message Queuing Telemetry Transport. In the following, instead of describing CPUs of devices (e.g., the CPU 332 of the server 300) as subjects of action, the devices (e.g., the server 300) will be described as subjects of action.

At T10, the server 300 receives status information from each of the plurality of print devices 100 and 200 using the XMPP connection. At T12, the server 300 updates the management database 50 by storing each status information received at T10 in the management database 50. The processes of T10 and T12 are executed periodically.

At T20, the user inputs an app activation instruction to the terminal device 10. The app activation instruction is an instruction to activate the app 442. When the terminal device 10 detects the input of the app activation instruction at T20, it activates the app 442. Once the app 442 is activated, the terminal device 10 displays a main screen SC2. Here, among the processes from T22 to be described later, processes executed by the terminal device 10 are executed according to the app 442.

At T22, the terminal device 10 sends a display determination request to the server 300 via the LAN I/F16. The display determination request is a command requesting a determination on whether to display the service guidance screen SC1. The display determination request includes the device ID of the selected device displayed as an icon in the device button BT4 in the service guidance screen SC1.

When the server 300 receives the display determination request from the terminal device 10 via the network I/F 316 at T22, it executes the display determination process illustrated in FIG. 4 at T24. The display determination process of the present embodiment is the same as the display determination process of the first embodiment, except that the device ID in the display determination request is used. In the present case, the server 300 determines to display the service guidance screen SC1 (see S70 in FIG. 4).

At T26, the server 300 sends a display instruction, which is an instruction to display the service guidance screen SC1, to the terminal device 10 via the network I/F 316. In another modification, the server 300 may sends web page data for displaying a web page including the service guidance screen SC1 to the terminal device 10 at T26. At T28, the server 300 updates the display history database 52 in the memory 334 (see S106 in FIG. 5). In the present embodiment, the server 300 determines that the service guidance screen SC1 has been displayed on the terminal device 10 upon sending of the display instruction, and updates the display history database 52. In a modification, the server 300 may update the display history database 52 when it receives, from the terminal device 10, a notification indicating that the service guidance screen SC1 has been displayed.

When the terminal device 10 receives the display instruction from the server 300 via the LAN I/F 16 at T26, it displays the service guidance screen SC1 according to the display instruction at T28. At T32, the user performs an operation on the service guidance screen SC1.

When the terminal device 10 detects an operation on the service guidance screen SC1 at T32, it sends operation information indicating which of the first button BT1, second button BT2, and end button BT3 was selected to the server 300 via LAN I/F16 at T34. The operation information further includes the viewing time of the service guidance screen SC1.

When the server 300 receives the operation information from the terminal device 10 via the network I/F 316 at T34, it updates the operation history database 54 at T36 by using the operation information received at T34 (see S110 in FIG. 5).

In this embodiment as well, as in the first embodiment, the condition for displaying the service guidance screen SC1 is based on the determination period, and is not easily affected by the frequency of use of the print device 100. The service guidance screen SC1 can be displayed at an appropriate frequency.

### Corresponding Relationships

The server 300 and the program 340 are an example of “server” and a “computer-readable instructions for a server”, respectively. T26 in FIG. 8 is an example of a process “send an instruction for displaying (N+1)th service guidance information”. The process realized by the process of T26 in FIG. 8 is an example of a “causing the terminal device to display service guidance information”

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification 1

The service guidance screen SC1 is not limited to the screen displayed on the app 42, but may be, for example, a pop-up or toast screen displayed on a browser program. Instead of the service guidance screen SC1, the terminal device 10 may add a message to the main screen SC2 that guides the user to the service. In this modification, the message added to the main screen SC2 is an example of “service guidance information”.

### Modification 2

The determination in S54 of FIG. 4 may not be executed. In this modification, the “third condition” can be omitted.

### Modification 3

In the display determination process in FIG. 4, when the service information corresponding to the selected device includes the date and time when use of the service was terminated (hereinafter referred to as “withdrawal date and time”), the CPU 32 may execute a determination using the withdrawal date and time in addition to the determination in S62. For example, the CPU 32 may decide to display the service guidance screen SC1 when the determination period elapses since the previous display date and time and a predetermined period (e.g., one month) elapses since the withdrawal date and time (S70). On the other hand, when the determination period elapse since the previous display date and time but the predetermined period of time has not elapsed since the withdrawal date and time (S72), the CPU 32 may decide not to display the service guidance screen SC1 (S72). In this modification, it is possible to suppress the service guidance screen from being displayed within a short period of time after the user has unsubscribed from the service. In this modification, the predetermined period of time having elapsed since the withdrawal date and time is an example of the “fourth condition”.

### Modification 4

In the second embodiment, one of the determinations in S216 and S218 may be executed and the other of the determinations in S216 and S218 may not be executed. Generally speaking, the “second condition” may be omitted or the “fifth condition” may be omitted.

### Modification 5

In the second embodiment, the CPU 32 may execute the process from S16 in FIG. 6 based on condition(s) different from the conditions of S216 and S218. The other condition(s) may be, for example, receiving a notification from the print device 100, or the cumulative usage time of the print device 100 exceeding a predetermined time. Here, the above notification may be a notification indicating that a specific event has occurred at the print device 100. The specific event may be, for example, that printing has been completed at the print device 100, that a colorant cartridge has been replaced at the print device 100, or that an error has occurred at the print device 100.

### Modification 6

In each embodiment, the communication systems 2 and 3 may include only one print device 100 instead of the plurality of print devices 100 and 200. The technology of each embodiment can also be employed in a system with only one print device 100.

### Modification 7

The determination in S58 in FIG. 4 may not be executed. In this modification, the “upper limit” can be omitted.

### Modification 8

The process of S56 in FIG. 4 may not be executed. In this modification, the display upper limit may not be changed from the default value. In this modification, “determine the upper limit” can be omitted.

### Modification 9

The process of S60 in FIG. 4 may not be executed. In this modification, the determination period may not be changed from the default period. In this modification, “determine the specific period” can be omitted.

### Modification 10

The process of S102 in FIG. 5 may not be executed. In this modification, the content of the message M1 may be unchanged. In this modification, “change a content of the (N+1)th service guidance information” can be omitted.

### Modification 11

In the third embodiment, the server 300 may determine the date and time to display the service guidance screen SC1 based on each database in response to the receipt of the display determination request at T22. Here, the date and time to display the service guidance screen SC1 is the date and time after the determination period has elapsed from the previous display date and time. The server 300 may send the determined date and time to the terminal device 10 at T26. The terminal device 10 may then monitor whether the date and time determined by the server 300 arrives, and display the service guidance screen SC1 when the date and time determined by the server 300 arrives. In addition to determining the date and time to display the service guidance screen SC1, the server 300 may, for example, determine to decide the content of the message M1 in the service guidance screen SC1 and the content of the trigger to display the service guidance screen SC1 (e.g., the remaining amount is equal to or less than a certain value). The server 300 may then send the determined contents to the terminal device 10 in addition to the determined date and time. The terminal device 10 may display the service guidance screen SC1 based on the contents determined by the server 300. In this modification, the process of sending the determined date and time to the terminal device 10 is an example of “send an instruction for displaying (N+1)th service guidance information” and “causing the terminal device to display service guidance information”.

### Modification 12

In the third embodiment, at least a portion of the databases 50 to 56 may be stored in the terminal device 10. For example, the database 50 to 56 may be stored in both the server 300 and the terminal device 10. Further, for example, a portion of the databases 50 to 56 may be stored in the server 300 and the rest of each of the databases 50 to 56 may be stored in the terminal device 10. A portion of the databases 50 to 56 may be stored in both the server 300 and the terminal device 10, and the rest of the databases 50 to 56 may be stored separately in the server 300 and the terminal device 10.

### Modification 13

In the embodiments described above, the processes of FIGS. 3 to 6 and FIG. 7 are realized by the CPUs 32 and 332 executing the programs. 40, 42, and 340. Instead of this, at least one of these processes may be realized by hardware such as a logic circuit, etc.

What is claimed is:

1. A non-transitory computer-readable recording medium storing computer-readable instructions for a terminal device,
wherein the computer-readable instructions, when executed by a processor of the terminal device, cause the terminal device to:
display, on a display unit of the terminal device, service guidance information guiding a user of the terminal device to a service suitable for a print device identified by identification information stored in a memory of the terminal device, and
wherein in a case where a first condition that a specific period elapses since Nth service guidance information is displayed on the display unit is fulfilled, the computer-readable instructions cause the terminal device to display (N+1)th service guidance information on the display unit, wherein N is an integer greater than or equal to 1.

2. The non-transitory computer-readable recording medium according to claim 1, wherein the first condition is that a program including the computer-readable instructions is activated after the specific period has elapsed.

3. The non-transitory computer-readable recording medium according to claim 1, wherein
the computer-readable instructions cause the terminal device to display, on the display unit, the (N+1)th service guidance information in a case where both of the first condition and a second condition are fulfilled, and
the second condition is that a remaining amount of a consumable of the print device is lower than or equal to a predetermined value.

4. The non-transitory computer-readable recording medium according to claim 1, wherein
the computer-readable instructions cause the terminal device to display, on the display unit, the (N+1)th service guidance information in a case where both of the first condition and a third condition are fulfilled, and
the third condition is that there is no history of use of the service.

5. The non-transitory computer-readable recording medium according to claim 1, wherein
the computer-readable instructions cause the terminal device to display, on the display unit, the (N+1)th service guidance information in a case where both of the first condition and a fourth condition are fulfilled, and
the fourth condition is that a predetermined period elapses since termination of use of the service.

6. The non-transitory computer-readable recording medium according to claim 1, wherein
the computer-readable instructions cause the terminal device to display, on the display unit, the (N+1)th service guidance information in a case where both of the first condition and a fifth condition are fulfilled, and
the fifth condition is that the terminal device sends a print instruction to the print device.

7. The non-transitory computer-readable recording medium according to claim 1, wherein
in a case where the terminal device receives current status information indicating a current status of the print device from the print device and both of the first condition and a condition based on the current status indicated by the current status information are fulfilled, the computer-readable instructions cause the terminal device to display, on the display unit, the (N+1)th service guidance information, and
in a case where the terminal device is unable to receive the current status information from the print device and both of the first condition and a condition based on a past status of the print device indicated by status information received from the print device in the past are fulfilled, the computer-readable instructions cause the terminal device to display, on the display unit, the (N+1)th service guidance information.

8. The non-transitory computer-readable recording medium according to claim 1, wherein
for each of a plurality of print devices configured to communicate with the terminal device, the memory stores the identification information identifying the print device,
in a case where first identification information is selected from among the plurality of identification information stored in the memory, the computer-readable instructions cause the terminal device to display, on the display unit, first service guidance information suitable for a first print device identified by the first identification information, and
in a case where the first identification information is selected, the computer-readable instructions do not cause the terminal device to display, on the display unit, another service guidance information suitable for another print device identified by identification information other than the first identification information among the plurality of identification information.

9. The non-transitory computer-readable recording medium according to claim 8, wherein
in a case where second identification information being different from the first identification information from among the plurality of identification information is selected before the specific period elapses since the Nth first service guidance information is displayed on the display unit, the computer-readable instructions cause the terminal device to display, on the display unit, second service guidance information suitable for a second print device identified by the second identification information, and
in a case where the first identification information is selected after the second service guidance information is displayed, even if the first condition is fulfilled, the computer-readable instructions do not cause the terminal device to display, on the display unit, the first service guidance information.

10. The non-transitory computer-readable recording medium according to claim 1, wherein
in a case where Nis an upper limit, the computer-readable instructions do not cause the terminal device to display, on the display unit, the (N+1)th or subsequent service guidance information.

11. The non-transitory computer-readable recording medium according to claim 10, wherein the computer-readable instructions further cause the terminal device to:
determine the upper limit based on first information, and
the first information includes at least one of:
information indicating a history of operations executed by the user on the terminal device while the service guidance information is displayed on the display unit;
a time during which the service guidance information is continuously displayed on the display unit;
information indicating a running status of the print device identified by the identification information stored in the memory;
a type of a consumable being available in the print device identified by the identification information stored in the memory; and
a model of the print device identified by the identification information stored in the memory.

12. The non-transitory computer-readable recording medium according to claim 1, wherein the computer-readable instructions further cause the terminal device to:
determine the specific period based on second information, and
the second information includes at least one of:
information indicating a history of operations executed by the user on the terminal device while the service guidance information is displayed on the display unit;
a time during which the service guidance information is continuously displayed on the display unit;
information indicating a running status of the print device identified by the identification information stored in the memory;
a type of a consumable compatible with the print device identified by the identification information stored in the memory; and
a model of the print device identified by the identification information stored in the memory.

13. The non-transitory computer-readable recording medium according to claim 1, wherein the computer-readable instructions further cause the terminal device to:
change a content of the (N+1)th service guidance information from a content of the Nth service guidance information.

14. A non-transitory computer-readable recording medium storing computer-readable instructions for a server configured to communicate with a terminal device,
wherein the computer-readable instructions, when executed by a processor of the server, cause the server to:
send, to the terminal device, data for displaying service guidance information guiding a user of the terminal device to a service suitable for a print device configured to communicate with the terminal device,
wherein in a case where a first condition that a specific period elapses since the Nth service guidance information is displayed on the terminal device is fulfilled, the computer-readable instructions cause the server to send data for displaying (N+1)th service guidance information, wherein N is an integer greater than or equal to 1.

15. The non-transitory computer-readable recording medium according to claim 14, wherein the first condition is that a program installed in the terminal device is activated after the specific period has elapsed.

16. The non-transitory computer-readable recording medium according to claim 14, wherein
the computer-readable instructions cause the server to send the data for displaying the (N+1)th service guidance information to the terminal device in a case where both of the first condition and a second condition are fulfilled, and
the second condition is that a remaining amount of a consumable of the print device is lower than or equal to a predetermined value.

17. The non-transitory computer-readable recording medium according to claim 14, wherein
the computer-readable instructions cause the server to send the data for displaying the (N+1)th service guidance information to the terminal device in a case where both of the first condition and a third condition are fulfilled, and
the third condition is that there is no history of use of the service.

18. The non-transitory computer-readable recording medium according to claim 14, wherein
the computer-readable instructions cause the server to send the data for displaying the (N+1)th service guidance information to the terminal device in a case where both of the first condition and a fourth condition are fulfilled, and
the fourth condition is that a predetermined period elapses since termination of use of the service.

19. The non-transitory computer-readable recording medium according to claim 14, wherein
the computer-readable instructions cause the server to send the data for displaying the (N+1)th service guidance information to the terminal device in a case where both of the first condition and a fifth condition are fulfilled, and
the fifth condition is that the terminal device sends a print instruction to the print device.

20. A control method of a system configured to cause a terminal device to display information, the control method comprising:
causing the terminal device to display service guidance information guiding a user of the terminal device to a service suitable for a print device configured to communicate with the terminal device,
wherein in a case where a first condition that a specific period elapses since Nth service guidance information is displayed on the display unit is fulfilled, the terminal device displays (N+1)th service guidance information, wherein N is an integer greater than or equal to 1.
